(19) United States
(12) Patent Application Publication
(10) Pub. No.: US 2015/0377422 A1
(43) Pub. Date: Dec. 31, 2015

(54) LIGHTING DEVICE AND A METHOD FOR ASSEMBLING THEREOF

(71) Applicant: KONINKLIJKE PHILIPS N.V., EINDHOVEN (NL)

(72) Inventors: Reinier Imre Anton DEN BOER, Eindhoven (NL); Martinus Hermanus Wilhelmus Maria VAN DELDEN, VENLO (NL); Vincent Stefan David GIELEN, Eindhoven (NL)

(21) Appl. No.: 14/765,736

(22) PCT Filed: Feb. 3, 2014
(86) PCT No.: PCT/IB2014/058746

§ 371 Date: Aug. 4, 2015

Related U.S. Application Data
(60) Provisional application No. 61/760,196, filed on Feb. 4, 2013.

(51) Int. Cl. F21K 99/00; B65H 81/06; F21S 4/00

(52) U.S. Cl. CPC F21K 9/17; F21K 9/54; F21S 4/008; B65H 81/06; F21Y 2103/003

(57) ABSTRACT

The present invention relates to a tubular lighting device (1) comprising a light engine (10) and a flexible material sheet (11) wrapped around said light engine (10) such that a tubular housing enclosing said light engine (10) is formed. The application further discloses an apparatus and method for assembling such a tubular lighting device (1).

### FIELD OF THE INVENTION

The present invention relates to the field of lighting devices, and is directed towards an improved lighting device together with a method and an apparatus for assembling such a lighting device.

### BACKGROUND OF THE INVENTION

The field of lighting devices includes a large variety of different lighting devices regarding light sources, construction, optical characteristics, etc. One type of lighting device is a tubular lighting device tube, such as a fluorescent tube, which is a well established standard light provider. Continuous development provides for new types of tubular lighting devices having advantages over the known technique. One recently developed tubular lighting device is lighting tubes comprising Light Emitting Diodes (LED). This technique has the main advantage of being very energy efficient, in that a very high amount of provided energy is converted into light. Thus, LED lighting tubes are environment friendly in relation to e.g. fluorescent tubes, and have thus become an increasingly common replacement.

A LED lighting tube is typically composed of a light engine comprising LEDs mounted in a line on a carrier, and possible other components such as heat-spreader/reflector annex, mechanical bridges such as an aluminum ray, etc. The LED lighting tube is assembled by arranging the light engine, together with possible further components such as a driver, in a prefabricated tubular housing of e.g. glass. The assembling of the lighting device is typically achieved by a plurality of (manual) steps, wherein some of these steps are complex assembly steps such as the insertion of long, slim and relatively vulnerable light engines and further components into a long narrow (glass) tube.

Moreover, handling and shipping of tubular lighting devices are relatively cost inefficient in view of the great portion of non-functional volumes, in the form of e.g. air or vacuum enclosed by the tube housing and air or vacuum between packed together tubular lighting devices, which need to be handled.

Thus, in view of the above there is still a need for improvement of tubular lighting devices.

### SUMMARY OF THE INVENTION

It is an object of the present invention to overcome the above mentioned problems and drawbacks, and to provide an improved tubular lighting device. It is also an object of the present invention to provide a method for assembling the tubular lighting device, and an apparatus for assembling the tubular lighting device.

According to a first aspect of the invention, the above mentioned and other objects are achieved by a tubular lighting device comprising: a light engine; and a flexible material sheet wrapped around said light engine such that a tubular housing enclosing said light engine is formed.

By light engine is meant a single component or a set of components, being arranged to provide light. By tubular housing is meant that the housing has an oblong shape and extends in a longitudinal direction. The tubular housing preferably has an essential rounded cross-section, such as in the shape of a circle or oval. Other cross-section shapes are of course also feasible. The housing may be wrapped by folding or rolling the flexible material sheet around the light engine.

By that the housing of the lighting device is wrapped around the light engine, the housing does not need to be fabricated before the assembling of the lighting device. Thus, the need for pre-fabricating housings, together with possible transportation of the pre-fabricated housings to another location for assembling of the lighting device, is redundant. Instead, the housing may be formed later in the assembling process. Further, the housing may be manufactured at a lower cost in comparison to e.g. conventional housing tubes that are manufactured by extruding a profiled plastic tube.

As an example, light engines may be manufactured globally, and shipped to regional or local assembling locations where possible further components are easily added, and where the housing is subsequently formed. The present invention provides a choice of when and where in the assembling process the housing is to be formed, and thus the production process may be optimized. The flexible material sheet of the housing of course still need to be transported, however this can in its pre-assembling form be transported with a much smaller non-functional volume, e.g. in rolls or as stacks of sheets.

Another advantage gained from the invention according the first aspect is that complex assembling steps of the lighting device may be simplified. Instead of assembling of the tubular lighting device by insertion of long, slim and relatively vulnerable light engines and further components into a long narrow (glass) tubular housing, the housing may be wrapped around the light engine. An apparatus for such an assembling will be disclosed in detail below.

By employing a flexible material sheet as the housing, the lighting device is much less prone to fracturing in comparison to a conventional housing made of a rigid material such as glass.

The light engine may have an oblong shape, being arranged to extend through essentially the whole tubular housing. Thus, a conventional lighting tube, such as a fluorescent tube, is imitated.

The light engine may comprise a light sheet comprising light emitting diodes (LEDs). The light engine may comprise a string of LEDs. Such LED strings are commercially available and may be purchased in the form of e.g. rolls of LED strings, such as a flat flexible cable, or as rigid sheets, such as a rigid printed circuit board (PCB), on which the LED string is arranged.

The light engine may comprise one or a combination of the following: a metal foil, a diffuser foil, a thermoformed structure, and a reflector. The components may be arranged in different shapes and positions in order to satisfy desired optical characteristics.

The flexible material sheet may be wrapped, or rolled, a plurality of turns. A more stable housing may thus be achieved. The plurality of turns also allows for a housing shell with a layered structure. The flexible material sheet may be formed such that the different turns, and thus different layers of the housing shell, comprise different materials. Thus, different optical characteristics may be achieved. For example, the (multi-)layered structure may provide for additional Fresnel reflections that create virtual light sources, thereby increasing the amount of (point) light sources that is observed, from outside the lighting device, and thus reducing the spottiness of the lighting device.

The flexible material sheet may be wrapped, or rolled, spirally. This is beneficial in that an improved fixation of the flexible material sheet after rolling may be achieved. In case of a perpendicular wrapping, or rolling, the flexible material sheet may require a fixation along the longitudinal edge of the flexible material sheet, i.e. in the longitudinal direction of the tubular housing, whereas a spiral wrapping, or rolling, may require a fixation of the rolled flexible material sheet only at the ends of the tubular housing as the spiral rolling in itself provides for a mechanical fixation.

In an embodiment the light engine is positioned spirally winding inside the tubular housing. In this embodiment the light engine spirals inside and in the longitudinal direction of the tubular housing. This provides for a predetermined light distribution which can be optimized by an appropriate choice of the number of spiral turns of the light engine inside the tubular housing.

One or a combination of the following filling materials may be arranged in the space between one or more turns of the flexible material sheet: a liquid, a gel, a viscous material. Advantages such as reduced Fresnel reflections —if required—, improved fire-retardation, heat-sinking function, mechanical stiffness, and electric safety may be achieved by the choice of a suitable filling material, or by a combination of suitable filling materials.

The housing may have a varying shell thickness. The variation in thickness may be achieved by a non-uniform shape of the flexible material sheet. Non-limiting examples of feasible non-uniform shapes are concave, convex, parabolic, tapered and trapezoidal shapes of the flexible material sheet. Different non-uniform shapes may provide different thickness profiles, i.e. variations in thickness, of the housing shell along the longitudinal axis of the lighting device. Different thickness profiles provide different optical characteristics.

According to a second aspect of the invention, the above mentioned and other objects are achieved by an apparatus for assembling a tubular lighting device, said apparatus comprising: a first reel for providing a light sheet to form part of a light engine; a second reel for providing a flexible material sheet; a wrapping device arranged to wrap or roll said flexible material sheet around said light engine, such that a tubular housing enclosing said light engine is formed.

The light sheet may be a LED roll, which is commercially available. The LED roll may comprise LEDs and reflectors arranged in a predetermined manner.

The first and second reels may be arranged such that the wrapping of the flexible material sheet is performed perpendicular, in-line or tilted/slanted towards a feeding direction of the first reel.

The apparatus may comprise one or more additional reels for providing additional sheets to form part of the light engine. The light sheet and the additional sheets together form a light engine. The wrapping device is arranged to wrap or roll the flexible material sheet around the formed light engine.

The first reel and additional reels may be arranged providing the same feeding direction. Thus, material sheets fed from rolls on the reels may be fed adjacently and facing each other. The forming of the light engine by the fed material sheets may thus be assisted.

As understood by the skilled person, the apparatus according to the second aspect of the invention may be embodied in many different configurations.

The above disclosed features of the first aspect are also applicable to this second aspect.

According to a third aspect of the invention, the above mentioned and other objects are achieved by a method for assembling a tubular lighting device, said method comprising: providing a light engine; providing a flexible material sheet; wrapping said flexible material sheet around said light engine such that a tubular housing enclosing said light engine is formed.

The apparatus according to the second aspect of the invention is arranged to perform the method according to this third aspect.

The above disclosed features of the first and second aspects are also applicable to this third aspect.

In summary, an improved tubular lighting device comprising a tubular housing of a flexible material sheet and a method and apparatus for manufacturing thereof are provided. Wrapped, or rolled, tubular housings not only save costs by providing flexibility in forming the production process, thus enabling elimination of shipping of non-functional volumes, but also eliminate the need for complex assembly steps such as insertion of fragile light engines into fracture sensitive glass tubes. Further, assembly steps which conventionally are performed manually may be automated, thus providing an improved efficiency in view of time and costs. In addition, wrapped, or rolled, housings are much less sensitive to fracturing—when compared to conventional glass tubes—and thus the risk of damage during product handling and transportation are also reduced substantially.

It is noted that the invention relates to all possible combinations of features recited in the claims.

### BRIEF DESCRIPTION OF THE DRAWINGS

This and other aspects of the present invention will now be described in more detail, with reference to the appended drawings showing embodiments of the invention.

FIG. 1 is an exploded view of a tubular lighting device according to an embodiment of the invention.

FIGS. 2a-2c illustrates assembly regions of an apparatus for assembling a tubular lighting device according to an embodiment of the invention.

FIGS. 3a-3d illustrates different embodiments of a flexible material sheet according to an embodiment of the invention.

FIG. 4 illustrates a spirally wrapped housing of a tubular lighting device comprising a light engine arranged between two turns of the housing according to an embodiment of the invention.

FIGS. 5a-5c illustrate a spirally wrapped housing of a tubular lighting device according to an embodiment of the invention.

FIGS. 6a-6c illustrate a spirally wrapped housing of a tubular lighting device according to an embodiment of the invention.

FIGS. 7a-7c illustrate a spirally wrapped housing of a tubular lighting device according to an embodiment of the invention.

FIG. 8 illustrates an embodiment of a flexible material sheet for a spirally wrapped housing of a tubular lighting device according to of the invention.

FIG. 9 illustrates wrapping of a flexible material sheet comprising perforations according to an embodiment of the invention.

FIG. 10 illustrates a cross-section of a tubular lighting device comprising an inner core for supporting a light engine arranged therein according to an embodiment of the invention.

FIG. 11 illustrates a method for assembling a tubular lighting device according to an embodiment of the invention.

As illustrated in the figures, the sizes of layers and regions are exaggerated for illustrative purposes and, thus, are provided to illustrate the general structures of embodiments of the present invention. Like reference numerals refer to like elements throughout.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

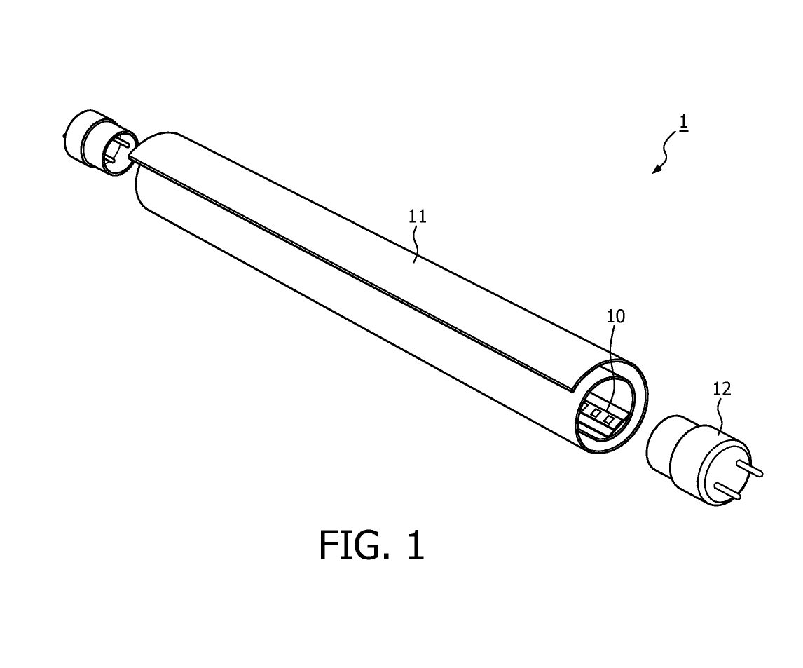

An exploded view of a tubular lighting device 1 is illustrated by FIG. 1. The lighting device 1 has an oblong shape, and extends along an axis. The tubular lighting device 1 comprises a light engine 10, and a housing formed by a flexible material sheet 11. The flexible material sheet 11 is wrapped around the light engine 10. The tubular lighting device 1 further comprises end caps 12 for providing a connection between the light engine and any component located outside of the housing. One or both end caps 12 may comprise a driver (not illustrated). The end caps 12 may be made of a transparent or non-transparent material.

The light engine 10 may be arranged along the whole extension of the lighting device 1, or alternatively along a part of the extension of the lighting device 1. The tubular lighting device 1 may comprise a single or a plurality of light engines.

The flexible material sheet 11 may be configured in many different ways, including but not limited to being transparent, diffuse, patterned, printed, holographic, perforated, performed at either sides, bi-refringent, multilayer-stack and wave-length selective stack.

The flexible material sheet 11 may comprise a plurality of sections of different sheet materials. The choice of material or materials may be made in order to gain advantageous functions such as fire-retardation, electric-safety functions, and filtering.

The flexible material sheet 11 may comprise one or a combination of the following: metal foil, metal strip, metal sheet and metal filled composite film. These materials may provide a heat-spreading and/or heat-sinking function. Non-limiting examples of suitable materials are aluminum, silver, gold, chrome, indium thin oxide (ITO) and composites thereof. Composites may comprise a matrix material, optionally curable, being filled with ceramics such as AlN, SiC, BN, Al₂O₃, or graphite.

The flexible material sheet 11 may comprise repetitive sections of heat-sinking and heat-spreading regions. The regions may overlap if the flexible material sheet 11 is wrapped a plurality of turns. Advantages such as intermediate heat distribution may thus be facilitated. Further, the overall heat-sinking resistance to the ambient air may be reduced.

The flexible material sheet may be functionalized to target optical support functions by comprising e.g. a diffusive exit window, a reflective or semi-reflective section, grating or lens like functions, and/or a Fresnel box envelope. Regions of the flexible material sheet 11 may alternatively, or in addition, comprise one or more regions of graded index or gradient thickness, wave-length specific sections such as a remote phosphor film or an interference stack. The size of the region or regions may span from a part of a wrap turn of the flexible material sheet 11 in the housing to a full wrap turn or multiple wrap turns.

Regions providing desired optical functions may be distributed over a portion of the flexible material sheet 11, which portion is arranged to form an internal portion of the housing shell, facing the inner space of the housing, and/or is arranged to form an exterior portion of the housing shell, facing the surroundings. The portions may for example comprise a remote phosphor portion with meso-optics or a diffuser arranged at an exterior portion of the housing shell.

The longitudinal edge of the wrapped housing may be fixated by means of e.g. melting, adhesives, laser welding, spot welding, form locking of foils in the flexible material sheet, shrink-wrapping, spiral-wrapping, or tape wrapping. The fixation technique may be chosen and adapted such that disassembly by unwrapping the flexible material sheet 11 is allowed.

The light engine 10 may be arranged in the inner space of the tubular housing. Further components, such as a driver, may thus easily be arranged in connection to the light engine 10 and in the inner space. Alternatively, further components, such as a driver, may be arranged as surface mounted device components onto e.g. a foil or a printed circuit board of the light engine 10. As disclosed above, a driver may also, or alternatively, be arranged in an end cap 12 of the tubular lighting device 1. Alternatively, the light engine 10 may be arranged between two turns of the flexible material sheet 11. The light engine may thus be fixated by adjacent turn layers, thus increasing the stability. Further, the need for fixating the light engine 10 may be alleviated, in comparison to the light engine 10 being arranged in the inner space of the housing.

The light engine 10 may comprise at least one LED in connection with primary optics, such as a lens, a grating, or a region of a wave-length converting material. Advantageous optical characteristics may be gained by one or a combination of these components. The wave-length converting material, being e.g. remote phosphor, may be arranged as one or more dots or in a line on the light engine 10. The lens may have a shape arranged to be supported by the contours of a hole in a reflector of the light engine 10. Different shapes may provide for different light characteristics. For example, a hexagonal base shaped lens may provide an elongation of the light beam in the longitudinal direction of the tubular housing.

Thus, the light engine 10 may comprise a large variety of components which may be arranged in many different configurations. The components may be added before wrapping of the flexible material sheet 11 around the light engine 10, or as a subsequent step. The invention thus provides an increased freedom in designing a production process for tubular lighting devices.

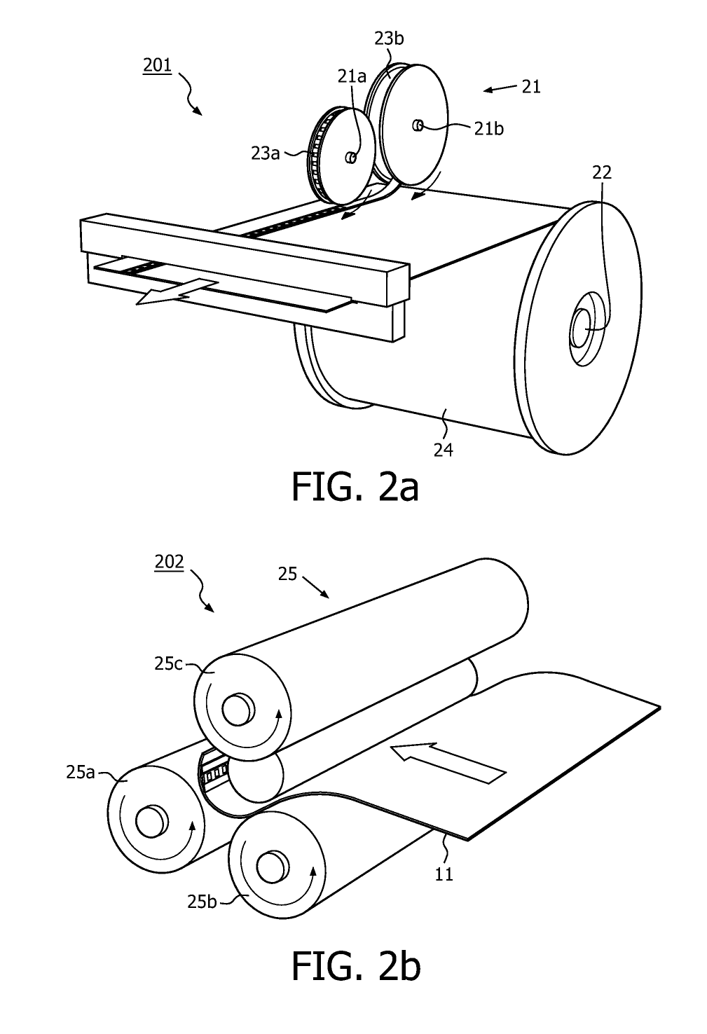

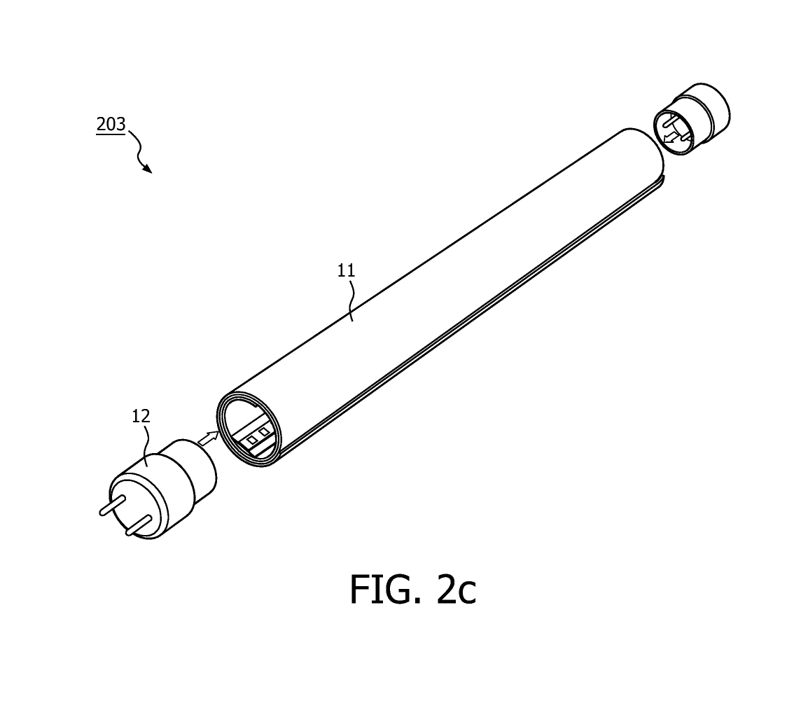

Different assembly regions of an apparatus for assembling the tubular lighting device 1 are illustrated in FIGS. 2a-2b. The apparatus comprises a first assembly region 201, a second assembly region 202, and a third assembly region 203.

In the first assembly region 201, a first reel 21a and a second reel 22 are arranged. On the first reel 21a, a light sheet roll 23a is arranged. The light sheet is a LED string on which LEDs are mounted in a line on a carrier of a flexible material. The carrier could e.g. be a printed circuit board (PCB) or a flat flexible cable (FFC).

Rolls of LED strings are commercially available. Such rolls may be cut to the desired length and provide a light engine without the need for connecting a plurality of LED components, such as L2s, thus reducing both handling and assembling costs. An L2 is a LED component comprising a PCB with soldered LEDs arranged on one side of the PCB. L2 is typically provided with a much shorter length than the desired length of a tubular lighting device, thus several L2s need to be connected in order to achieve a light engine being arranged to extend along essentially the whole length of the lighting device. Thus, the typically complex step of connecting of LED components, such as L2s, may be eliminated.

Other types of light sheets on rolls are of course also feasible.

The first reel 21a is part of a set of reels 21. The set of reels 21 further comprises an additional reel 21b. In this embodiment, on the additional reel 21b, an additional roll 23b is arranged. The additional roll 23b comprises in this case a reflector material to be included in the light engine of the lighting device 1 being assembled.

The set of reels 21 is arranged such that the light sheet and the additional sheet face each other when unwinding from their respective rolls, and fed in the feeding direction provided by the set of reels 21. Thus, a multilayered light engine is formed during the unwinding of the first roll 23a and the additional roll 23b.

The set of reels 21 may comprise further additional reels comprising additional rolls of light engine material such as metal foils, stabilizing sheets, lamination sheets, etc. to be included in the light engine.

The second reel 22 comprises a flexible material sheet roll 24. The flexible material sheet is to be wrapped, or rolled, around the light engine thereby forming the housing for the tubular lighting device.

Non-limiting examples of suitable sheet materials are polyethylene terephthalate (PET), biaxially-oriented polyethylene terephthalate (BoPET), polysulfone (PES), polycarbonate (PC), polyethylene naphthalate (PEN), poly(methyl methacrylate) (PMMA), and thin sheet glass, optionally with a high-end exterior finish.

The flexible material sheet may comprise a single layer or a multilayered structure. The multi-layered structure may comprise different material layers, in order to achieve improved fire retardation and/or improved electrical safety functions. Different material sheets may for example be applied as alternating sheets in order to achieve such advantages. Further, a stack or roll of alternating sheet materials, or a single composite sheet, may provide wavelength specific, i.e. filtering, functions when wrapped to form a housing of the tubular lighting device. The stack may for example be optimized for transmission in a given part of the spectrum, e.g. blue, or for reduction of the spottiness by adding, or increasing, the number of virtual light sources thereby increasing the number of light sources that is observed from outside of the housing, for example via Fresnel reflections.

Alternatively or additionally, the flexible material sheet may be formed by regions of different materials, optionally arranged in a repetitive pattern, also in order to achieve desired optical properties.

A flexible material sheet comprising multiple layers and/or a plurality of regions of different materials, may be formed in a pre-assembly region being arranged previous to the first assembly region 201, possibly in the same apparatus.

The space between one or more turns of wrapped flexible material sheet may be filled with a filling material such as a liquid, a gel or a viscous material. The filling material may be chosen to e.g. reduce Fresnel reflections, to improve fire-retardation, to provide heat-sinking to ambient, to provide mechanical stiffness and/or to provide electric safety. The filling material may be filled during the wrapping process, or as a previous or subsequent step.

The second reel 22 is arranged such that the flexible material sheet faces the sheets provided from rolls arranged on reels of the first set of reels 21. The light sheet from the light sheet roll 23a, the flexible material sheet from the flexible sheet roll 24, and the additional sheet from the additional sheet roll 23b are fed towards the second assembly region 202.

A cutting device (not shown) may be arranged in the first assembly region 201 or in the second assembly region 202. The cutting device is arranged to cut off a portion of the light sheet, the additional sheet and the flexible material sheet, from their respective rolls.

A fixation device (not shown) may be arranged in the first assembly region 201 or in the second assembly region 202. The fixation is arranged to fixate the light sheet to the additional sheet in order to form the light engine to be included in the lighting device. The fixation device may be arranged to perform the fixation by means of the following non-limiting examples of fixation techniques: lamination, thermosonic adhesion, chemical bonding, physical bonding, or form locking. Some of these techniques require providing additional materials such as lamination sheets, adhesive, shrinking plastics, etc.

As an example the light engine may be formed by laminating a transparent sheet material together with an aluminum heat-spreading foil, from a first additional roll, and a diffuser foil from a second additional roll. Alternatively, sheets may be attached to each other by thermosonic bonding, chemical and/or physical bonding, such as gluing by means of an adhesive or UV light, and/or form locking, such as by means of a shrinking material. Optionally, additional sheets to form part of the light engine may be interleaved to be form locked, sheer locked or clamped towards each other and/or to a metal strip, preferably thin, and/or to the light sheet.

As yet another example light sheet, e.g. comprising blue LEDs, may be laminated towards a thin metal strip or rigid heat-sinking board, such as a sheet clad honey-comb structure. A tubular lighting device requiring a larger heat-spreading capacity, i.e. providing a high lumen output, may thus be achieved.

Returning to the embodiment illustrated in FIG. 2a-2c, a part of the second assembly region 202 is illustrated by FIG. 2b. When the light engine has been formed, the cut flexible material sheet 11 is to be wrapped, or rolled, around the light engine. For that purpose, the second assembly region 202 comprises a wrapping device 25.

The wrapping device 25 comprises three rollers 25a, 25b, and 25c. The cut light engine and cut flexible material sheet 11 are inserted in the wrapping device. By movement of the rollers 25a, 25b, 25c, the flexible material sheet is wrapped, or rolled, around the light engine, such that a tubular housing enclosing the light engine is formed.

The longitudinal edge, extending along the tubular housing, of the flexible light material sheet 11 may be fixated by means of e.g. melting, adhesives, laser welding, spot welding, form locking of foils in the flexible material sheet, shrink-wrapping, spiral-wrapping, or tape wrapping. The fixation technique may be chosen and adapted such that disassembly by unwrapping the flexible material sheet is allowed, and a suitable device for performing the edge fixation may be arranged in the second assembly region 202. In case of spiral wrapping, or rolling, of the flexible material sheet 11 may require only a fixation at the open ends of the tubular housing and, hence, no fixation at the longitudinal edge of the flexible material sheet 11 is required.

The tubular housing, comprising the light engine, is transported to the third assembly region 203, which is illustrated in FIG. 2c. Here, the lighting device is finalized. Further components, such as a driver for the lighting device, may be added here. In order to improve the uniformity of the lighting tube, a diffuser may be deployed at a light exit window. As another example, a local Fresnel box (half-tube) may be arranged in the lighting device for improving the light uniformity.

End caps 12 may be arranged at the open ends of the tubular housing, for closing the housing, and for providing an electrical connection to the light engine, and possible further components, from outside the lighting device. The end caps 12 may be arranged by snap fitting to the flexible material sheet 11.

Alternatively, the end caps 12 may be arranged before wrapping of the flexible material sheet 11. Thus, the flexible sheet material 11 is wrapped around both the light engine and the end caps 12.

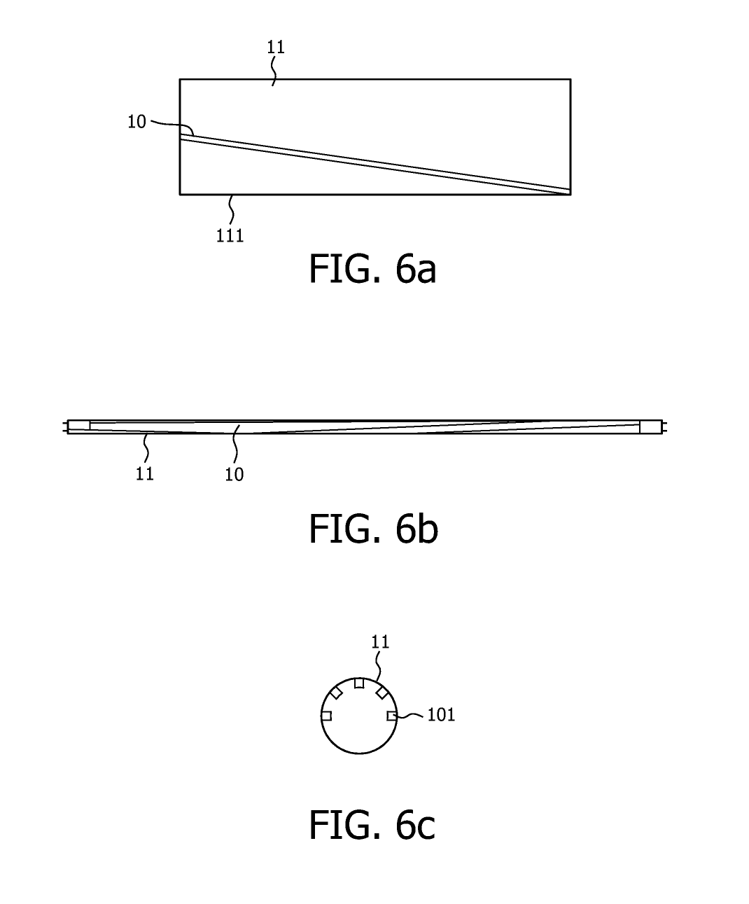

A driver or drivers may be arranged in one end cap 12 or both end caps 12. A more detailed description of the driver is provided in connection to FIG. 6.

The end caps 12 may be arranged such that the wrapped flexible material sheet 11 substantially covers the end caps 12. The appearance of dark ends due to the end caps 12 may thus be minimized by means of wave guiding.

The apparatus may comprise further components in above disclosed or additional assembly regions for providing functions such as screen-printing or slit-coating of a diffuser film being an additional sheet, arranging heat-spreading/heat-sinking films in one or more of the additional sheets or the flexible material sheet, providing sheets to form part of the light engine with embossed optics and/or thermo formed structures, such as lenses (e.g. Fresnel lenses), or screen-printing a film, preferably a thin film, of one or more remote phosphor films which in turn may be laminated towards a light engine sheet.

In the embodiment illustrated by FIGS. 2a-2c, the reels of the apparatus are arranged such that they provide the same feeding direction for their respective roll. In other embodiments, the second reel 22 may be provided with another feeding direction, in order to e.g. achieve a different wrapping. The wrapping could be performed e.g. perpendicular to the feeding direction of the first roll 23a and/or the additional roll 23b, or alternatively tilted or slanted towards this feeding direction. Thus, the wrapping may be in the form of e.g. spiral. The possibility to select a wrapping shape may be a beneficial when designing the housing construction in order to achieve desired optical characteristics.

In the embodiment illustrated by FIGS. 2a-2c, the first assembly region 201, the second assembly region 202, and the third assembly region 203 are arranged in a single apparatus. In another embodiment, these and possible further assembly regions may be separated, in total or in part, from each other. For example, a light engine in the form of a LED strings may be assembled and arranged as a roll at a first location, and transported to a second location. At the second location, the LED string may be combined with further additional functionalized sheet or roll of material, in an apparatus as disclosed above. Alternatively, LED rolls may be manufactured in-house, and at a later stage be combined with a set of functionalized foils, rolls or sheets of material.

The flexible material sheet may be wrapped around the light engine in connection to the assembling of the light engine, or optionally at a later stage. The lighting device may be finalized at a further later stage, at the same or at another location, possible including addition further components in the housing. Thus, as has become clear, the manufacturing process may be designed very freely.

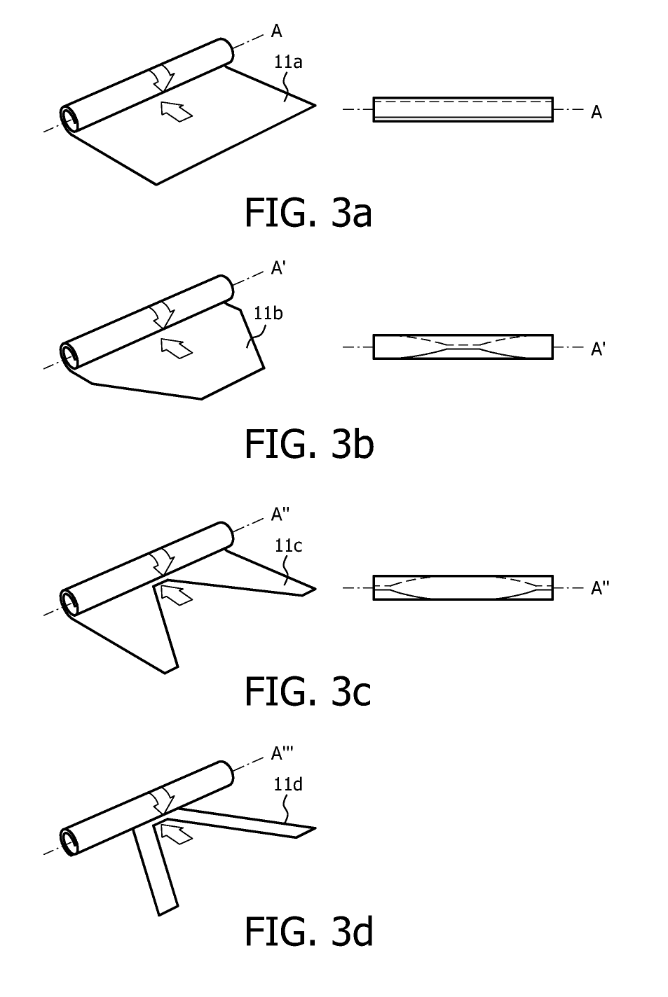

Examples of how the flexible light material sheet 11 may be formed are illustrated by FIGS. 3a-3c. Different thickness profiles of the lighting device housing shell may be achieved by different forms of the light material sheet 11 to be wrapped around the light engine.

A uniform flexible material sheet 11a is illustrated in FIG. 3a. This uniform shape corresponds to the flexible material sheet 11 of the embodiment illustrated by FIGS. 2a-2c. By the uniform shape, a uniform thickness of the shell of the housing, along its axis A, is provided when the flexible material sheet 11a is wrapped.

A non-uniform flexible material sheet 11b is illustrated in FIG. 3b. The flexible material sheet 11b is tapered along its feeding direction, and in another embodiment the tapered flexible material sheet 11b ends in a point thus having a triangular shape (not shown). The tapered shape of the flexible material sheet 11b in this embodiment facilitates an easy mechanical fixation, e.g. by point welding the end of the flexible material sheet 11b. Thus, a housing shell having a thicker center portion and thinner outer portions, along its axis A′, is provided when the flexible material sheet 11b is wrapped.

Another non-uniform flexible material sheet 11c is illustrated in FIG. 3c. The flexible material sheet 11c is slotted along its feeding direction. Thus, a housing shell having a thinner center portion and thicker outer portions, along its axis A″, is provided when the flexible material sheet 11c is wrapped.

Another non-uniform flexible material sheet 11d is illustrated in FIG. 3d. The flexible material sheet 11d is shaped as the letter V, i.e. with slanted arms that have an equal width. Thus, after wrapping or rolling of the flexible material sheet 11d a housing shell with a constant thickness is provided. This provides for an improved fixation of the flexible material sheet 11d with a smaller fixation region in that only ends of the V-shaped flexible material sheet 11d need to be fixated instead of the entire longitudinal edge.

A combination of the embodiments of the different shapes of the flexible material sheets 11a, 11b, 11c and 11d is also possible. For example, in an embodiment one end of the flexible material sheet, e.g. where the wrapping or rolling of the sheet starts, is slotted and the opposite end of the flexible material sheet is tapered (or vice versa) which may provide for a uniform thickness of the rolled material sheet. Or, in other wordings, to obtain a uniform thickness the shape of the flexible material sheet at one end, where the rolling of the sheet starts, is inverse to the shape of the flexible material sheet at its opposite end, where the rolling of the sheet ends, to obtain a uniform thickness of the rolled flexible material sheet.

The possibility to choose different thickness profiles may be beneficial when designing the housing construction in order to achieve desired optical characteristics.

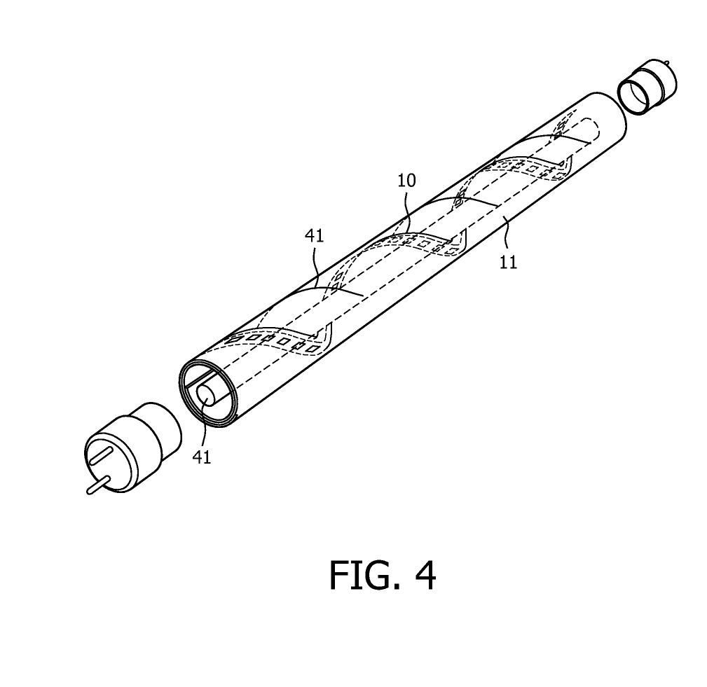

An alternative arrangement of the light engine 10 in the tubular lighting device is illustrated in FIG. 4. Instead of wrapping the flexible material sheet 11 such that the light engine 10 is provided in the inner space of the wrapped housing, the light engine 10 is arranged between two turns of the flexible material sheet 11. Thus, the light engine 10 is arranged between two layers of the flexible material sheet 11. Additionally, the flexible material sheet 11 is spiral wrapped. This is advantageous in that not the entire longitudinal edge of the wrapped, or rolled, flexible material sheet 11, needs to be fixated with separate means, but only a fixation may be required at the open ends of the tubular housing formed by the wrapped, or rolled, flexible material sheet 11. The light engine 10 is arranged such that the light provided by the light sheet in the light engine 10 is directed inwards towards the inner space of the housing. In the inner space of housing, a reflector 41 is arranged. The reflector 41 reflects the light, provided by the light engine 10, through the housing shell and further outwards. Alternatively, no reflector 41 is arranged in the housing.

In an alternative embodiment, the light engine is arranged adjacent to the exterior surface of the housing. Thus, the light engine is arranged outside the housing. The light engine may be arranged similar to the embodiment above, i.e. such that the light engine provides light inwards towards the inner space of the housing. The light engine may be arranged as a spiral or in any other suitable configuration. By arranging the light engine outside the housing, the heat produced by the light engine is transmitted to the housing to a lower extent than when compared to embodiments where the light engine is arranged in the housing. This embodiment may thus be preferred in view of thermal conditions.

In yet another embodiment, being a combination of the above disclosed embodiments, the light engine is arranged partly between two turns of the flexible material sheet, and partly outside the housing and adjacent to the exterior of the housing.

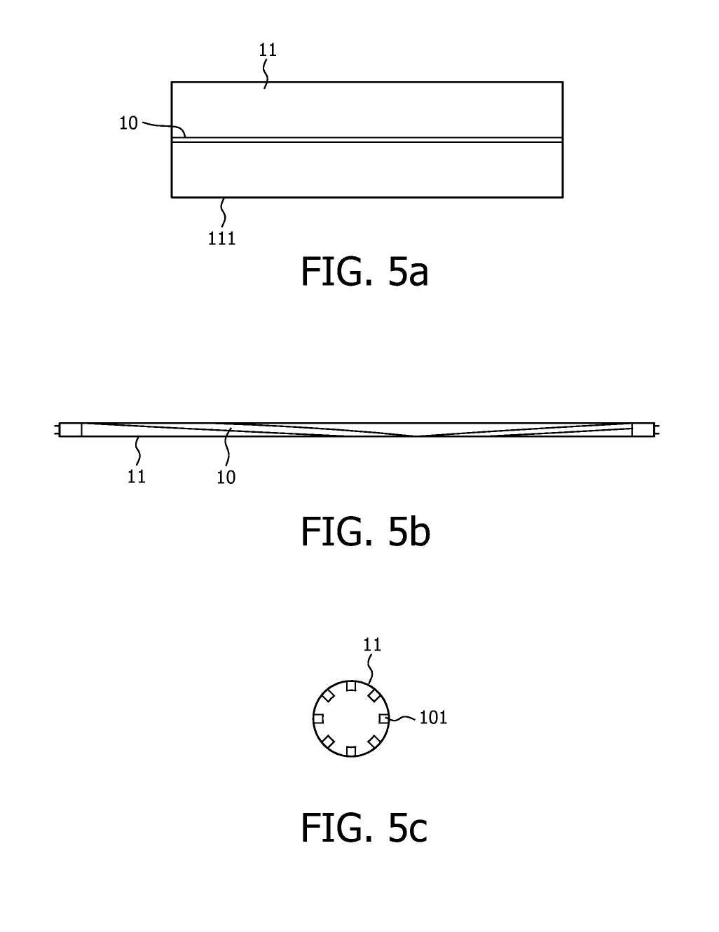

FIGS. 5a-c, 6a-c and 7a-c illustrate other embodiments of a spirally wrapped housing according to the invention in which the orientation of the light engine 10 with respect to the flexible material sheet 11 before rolling of the flexible material sheet 11 is varied to create a predetermined distribution of the LEDs 101 in the tubular housing, which distribution can also be varied by varying the pitch of the LEDs 101. In these embodiments the light engine 10 is of a flexible material, for example a flat flexible cable with LEDs.

FIG. 5a illustrates the flexible material sheet 11 before rolling it into a tubular shaped housing in which the orientation of the light engine 10 is parallel to the long or longitudinal edge 111 of the flexible material sheet 11. By spirally rolling, or wrapping, the flexible material sheet 11 by one turn, the light engine 10 will be positioned in a spirally winding orientation inside the tubular housing with one complete spiral turn, i.e. the light engine 10 is positioned inside the tubular housing such that it makes one full turn of 360 degrees in the longitudinal direction of the tubular housing. The light engine 10 spirals in the longitudinal direction of the tubular housing thereby covering 360 degrees of the inner circumference of the tubular housing, as is illustrated in FIG. 5b. FIG. 5c is a schematic projected cross-section of the spirally rolled, or wrapped, tubular housing illustrating that in this embodiment the LEDs 101 of the light engine 10 are distributed in the longitudinal direction along the inner circumference of the tubular housing. Note that the embodiment shown in FIG. 4 shows an embodiment of a spirally rolled, or wrapped, housing in which the light engine 10 is positioned inside the tubular housing making three full spiral turns of 360 degrees in the longitudinal direction of the tubular housing.

FIG. 6a illustrates the flexible material sheet 11 before rolling it into a tubular shaped housing in which the orientation of the light engine 10 with respect to the long or longitudinal edge 111 of the flexible material sheet 11 is such that after spirally rolling the flexible material sheet by one turn, the light engine 10 is positioned in a spirally winding orientation inside the tubular housing such that it makes half of a complete spiral turn, viz. 180 degrees, i.e. the light engine 10 is spiraling in the longitudinal direction of the tubular housing thereby covering 180 degrees of the inner circumference of the tubular housing, as is illustrated in FIG. 6b. Thus, in this case the light sources, e.g. LEDs 101, of the light engine 10 are distributed only on one half of the inner circumference of the tubular housing, for example the upper half of the tubular housing. FIG. 6c is a schematic projected cross-section of the spirally rolled, or wrapped, tubular housing illustrating that in this embodiment the LEDs 101 of the light engine 10 are distributed in the longitudinal direction along half of the inner circumference of the tubular housing.

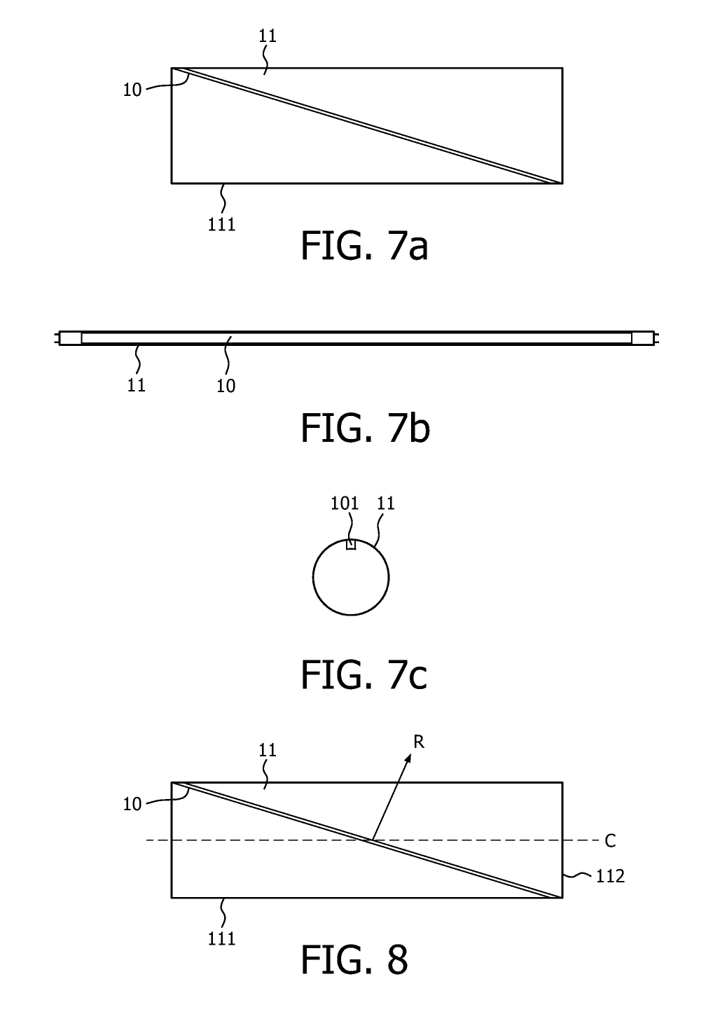

FIG. 7a illustrates the flexible material sheet 11 before rolling it into a tubular shaped housing in which the orientation of the light engine 10 with respect to the long or longitudinal edge 111 of the flexible material sheet 11 is such that after spirally rolling the flexible material sheet 11 by one turn, the light engine will be positioned in the tubular housing parallel to and in the direction of the longitudinal direction of the tubular housing, as is illustrated in FIG. 7b. Thus, in this case the light engine 10 does not spiral inside the spirally rolled tubular housing but is positioned as a row of LEDs 101 extending in the longitudinal direction of the tubular housing. FIG. 7c is a schematic projected cross-section of the spirally rolled, or wrapped, tubular housing illustrating that in this embodiment the LEDs 101 of the light engine 10 are distributed as a row in the longitudinal direction of the tubular housing.

FIG. 8 shows a further embodiment in which the flexible material sheet 11 before rolling is shaped as a parallelogram wherein the short edges 112 of the flexible material sheet 11, before rolling it into a spirally rolled, or wrapped, housing, are not perpendicular to the long or longitudinal edges 111 of the flexible material sheet 11, which longitudinal edges 111 run parallel to a central axis C of the tubular housing, but wherein the short edges 112 are slanted wherein the angle between the short edges 112 and long edges 111 of the flexible material sheet 11 is smaller or larger than 90 degrees. The angle between the short edges 112 and long edges 111 of the flexible material sheet 11 is preferably equal to the angle between the rolling or wrapping direction R of the flexible material sheet 11 and the central axis C. This may be advantageous in that alignment of the short edge 112 of the flexible material sheet 11 during the spirally wrapping of the flexible material sheet 11 results in the predetermined spiral rolling of the flexible material sheet 11. Furthermore, this particular shape of the flexible material sheet 11 results in straight edges at the open ends of the tubular housing after the spiral rolling of the flexible material sheet 11. This embodiment in which the flexible material sheet 11 has the shape of a parallelogram can also be applied to the other embodiments of the tubular housing in which a spiral wrapping or rolling is applied, for example with another orientation of the light engine 10 with respect to the flexible material sheet 11.

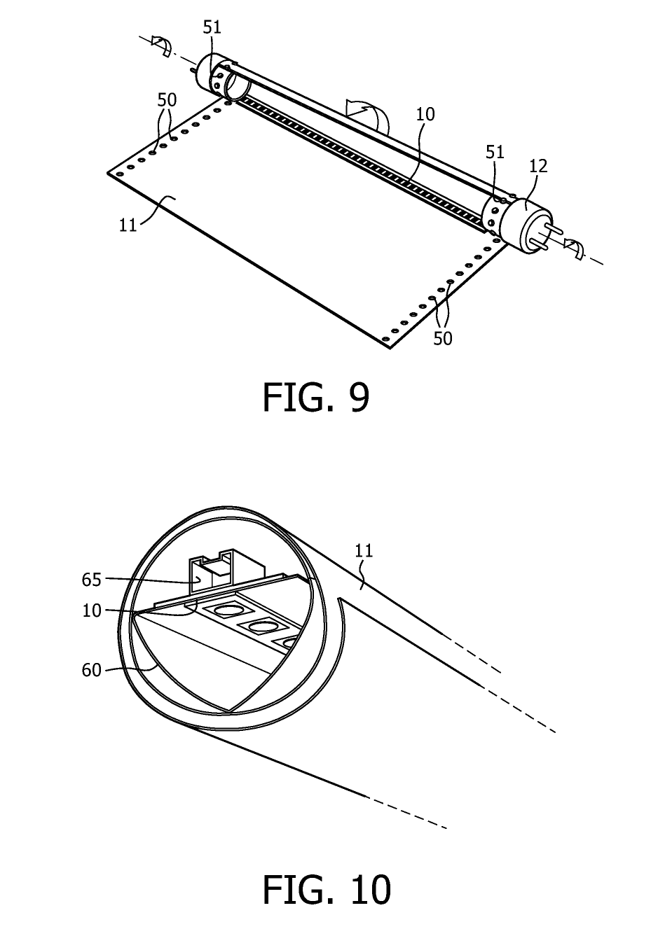

Preferably, in embodiments where the light engine is arranged (partly) outside the housing, the lighting device is arranged for low voltage applications, in order to ensure electrical safety for e.g. a person handling the lighting device. The flexible material sheet 11 may be perforated, as illustrated in FIG. 9. The perforation is arranged to assist the wrapping process. The flexible material sheet 11 comprises perforated holes 50 arranged in lines along each edge being arranged along the feeding direction during wrapping. During wrapping of the flexible material sheet 11, the perforated holes 50 receive teeth 51 arranged in end caps 12. Thus, the flexible material sheet 11 is stabilized and fixated to the end caps 12 during the wrapping, thus alleviating the risk that the flexible material sheet 11 shears during the wrapping. Alternatively, the teeth 51 may be arranged in other components, such as on a driver or a portion of the wrapping device 25.

In an embodiment where the light engine 10 is provided in the inner space of the wrapped housing, an inner core 60 may be provided as illustrated by FIG. 10. The inner core 60 is arranged to support the light engine 10 such that the light engine 10 is not located adjacently to the flexible material sheet 11. The inner core 60 may have a triangular cross-section. The inner core 60 may extend along essentially the whole light engine 10. The inner core 60 provides stability to the tubular lighting device 1. By the non-adjacent arrangement of the light engine 10, provided by the inner core 60, heat provided by the light engine 10 is not directly transmitted to the housing, thus alleviating the risk of damages on the housing due to high temperatures.

The inner core 60 is formed as a portion of the flexible material sheet 11. The inner core 60 is formed of two rigid portions which together with the light engine forms a triangular cross-section of the lighting device. The light engine 10 is arranged such that light from the light sheet of the light engine 10 is provided towards the inner core 60. The inner core 60 is of a light-transparent material, optionally comprising material sheet providing optic functionality such as filtering, optimization for transmission of a specific wave-length, etc.

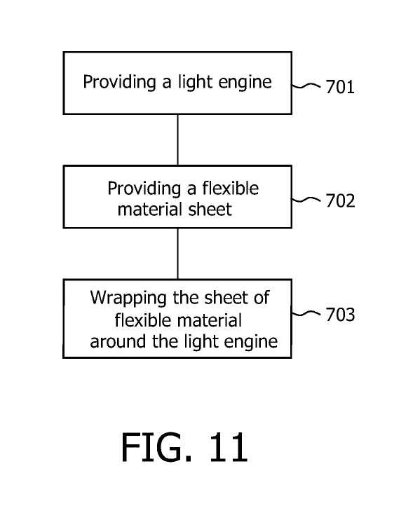

Optionally, and as illustrated in FIG. 11, a driver 65 may be arranged in the inner core of the housing. The driver 65 is arranged at the back-side of the light engine 10, meaning the side from which no light is provided. By arranging the driver 65 at the back-side of the light engine 10, the driver 65 does not block any part of the path of the light provided by the light engine 10. Thus, the lighting device 10 may be arranged to have full length illumination, without any dark areas due to the arrangement of the driver 65. For example, if the driver 65 is arranged at an end cap 12 of the lighting device, the lighting device may appear to have dark ends.

The driver 65 may provide functionality such as voltage control (low voltage control or high voltage control), or suppression of harmonics or distortions in the mains supply by means of soft-magnetic filers (preferably arranged close to or at the PCB of the driver 65). The driver 65 may also provide a mechanical reinforcement of the lighting device 10 by contributing to the stability of the construction, e.g. during wrapping of the flexible material sheet 11 in an embodiment where the driver 65 is provide before the wrapping process.

By the inner core 60, the driver 65 may be supported such that it is arranged non-adjacently to the flexible material sheet 11.

Alternatively, the inner core 60 may be a separate component which does not form part of the housing. The inner core 60 may be arranged in the housing after the wrapping of the flexible material sheet 11, e.g. at a finalization stage of the lighting device. Alternatively, the inner core 60 may be provided together with the light engine 10, such that the flexible material sheet 11 is wrapped around the light engine 10 together with the inner core 60.

A method for assembling the tubular lighting device 1 according to any of the above disclosed embodiments is illustrated in FIG. 8. The method comprises providing a light engine 701, providing a flexible material sheet 702, and wrapping the sheet of flexible material around the light engine 703. The method may be performed by the above disclosed apparatus, and alternative configurations of that apparatus.

The method may comprise a step of providing further components, such as a driver, in the housing. This step may be performed directly after or spaced in time from the step of wrapping the flexible material sheet.

The method may comprise a further step of fixating a longitudinal edge of the flexible material sheet. The fixation may be achieved by means of e.g. melting, adhesives, laser welding, and spot welding, form locking of foils in the flexible material sheet, shrink-wrapping, spiral-wrapping, or tape-wrapping. These connections may be optimized for disassembly by unrolling.

As may have become clear from the previous, the possibilities for designing the assembly process for the tubular lighting device are substantial and the above disclosed embodiments are just examples. The person skilled in the art realizes that the present invention by no means is limited to the preferred embodiments described above. On the contrary, many modifications and variations are possible within the scope of the appended claims. For example, different cross-section shapes, other than circular or oval, of the tubular lighting devices shapes may be utilized. As another example, the lighting device may be assembled according to the disclosed method by a differently configured apparatus than the one disclosed herein. For example, the sheets provided to form the light engine may be provided in a stack rather than in rolls. Alternatively or additionally, the flexible material sheet may be provided in stacks instead of as rolls.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. A tubular lighting device comprising:
a light engine; and
a flexible material sheet wrapped around said light engine such that a tubular housing enclosing said light engine is formed.

2. The tubular lighting device according to claim 1, wherein the light engine comprises a light sheet comprising light emitting diodes.

3. The tubular lighting device according to claim 2 wherein the flexible material sheet is spirally wrapped.

4. The tubular lighting device according to claim 3 wherein the light engine is positioned spirally winding inside the tubular housing.

5. The tubular lighting device according to claim 3 wherein the flexible material sheet is wrapped a plurality of turns.

6. The tubular lighting device according to claim 5, wherein one or a combination of the following filling materials is arranged in the space between one or more turns of the flexible material sheet: a liquid, a gel, a viscous material.

7. The tubular lighting device according to claim 6 wherein the light engine is arranged between two turns of the flexible material sheet.

8. The tubular lighting device according to claim 5 wherein the light engine is arranged in the inner space of the tubular housing.

9. The tubular lighting device according to claim 8 further comprising an inner core structure arranged to support the light engine, such that the light engine is arranged non-adjacently to the flexible material sheet of the housing.

10. The tubular lighting device according to claim 9, wherein the housing has a varying shell thickness.

11. The tubular lighting device according to [symbol] , wherein the light engine comprises one or a combination of the following: metal foil, diffuser foil, thermo-formed structures, and reflector.

12. The tubular lighting device according to claim 11, wherein the flexible sheet material comprises a perforated track arranged to receive a corresponding teethed track during wrapping of the flexible material sheet.

13. An apparatus for assembling a tubular lighting device, said apparatus comprising:
a first reel for providing a light sheet to form part of a light engine;
a second reel for providing a flexible material sheet;
a wrapping device arranged to wrap said flexible material sheet around said light engine, such that a tubular housing enclosing said light engine is formed.

14. The apparatus according to claim 12, further comprising one or more additional reels for providing additional sheets to form part of the light engine.

15. A method for assembling a tubular lighting device, said method comprising:
providing a light engine;
providing a flexible material sheet;
wrapping said flexible material sheet around said light engine such that a tubular housing enclosing said light engine is formed.
